(19) United States
(12) Patent Application Publication
(10) Pub. No.: US 2006/0120427 A1
(43) Pub. Date: Jun. 8, 2006

(54) Novel method for the determination of gaseous mercury (0)

(76) Inventor: Luca D'Ottone, Key Biscayne, FL (US)

Correspondence Address: LUCA D'OTTONE, 251 GAUEN DR 305 E, KEY BISCAYNE, FL, 33149, US

(21) Appl. No.: 11/004,683

(22) Filed: Dec. 4, 2004

(51) Int. Cl. H01S 3/22

(52) U.S. Cl. 372/55

(57) ABSTRACT

The object of this invention is a novel method for the LASER Induced Fluorescence (LIF) detection and quantitative determination of gaseous mercury (o) in several gas matrixes. Mercury is a metal having not negligible vapor pressure at standard pressure and temperature. It has been related to a number of atmospheric phenomena, but its role in atmospheric chemistry is still not clear. Mercury (o) can be monitored by exciting either via 1-photon LIF or 2-photon LIF and subsequently detecting the fluorescent light with and appropriate Photomultiplier Tube (PMT).

### BACKGROUND OF THE INVENTION

1. Field of the Invention

The present invention relates to a method of detecting gaseous mercury metal in gaseous mixtures. The invention can be used to analyze mercury concentrations in air or in open space and interstellar clouds. The process and apparatus in general can be adapted to a wide range of gaseous matrix.

Gaseous mercury is present in terrestrial uncontaminated ecosystem in concentrations ranging from 1 to 10 ng*m⁻³. Gaseous mercury concentration can reach 1 mg*m⁻³ in contaminated environments. Issues related to the environmental importance of gaseous mercury have recently been re-considered by the scientific community.

Mercury's pathways and distribution in the atmosphere are not clear, so it is role in the ozone hole. In addition to that mercury vapors are toxic and may lead to chronic disease if people are routinely exposed to mercury vapors.

2. Description of the Related Art

Current commercial apparatus are based on trapping Hg on a gold amalgam and measuring then the total mercury by atomic absorption. These methods involve flow calculations and complex instrument calibrations.

The method object of this invention is purely based on straight forward in situ determination of gaseous mercury as present in air by Laser Induced Fluorescence (LIF). The results are expressed directly as concentrations and very limited additional data manipulation is required.

As far as I am concerned no relevant US or foreign patent has been issued. There have been two (2) published studies that only focused on specific combinations of excitation/detection wavelength; and there is one study generally dealing with excitation wavelengths of Mercury. These studies are respectively:
(a) Bauer, et al. Journal of Photochemistry and Photobiology, A: CHEMISTRY 157 (2003) 247-256.
(b) Bauer, et al. Journal of Environmental Monitoring 4 (2002) 339.
(c) Michael, et al. Journal of Physical Chemistry 78 (1974) 482.
   All these printed publications quote a number of references, that were judged to be less relevant for the purpose of this patent.

In addition to that there are two patent documents by Tomei et al., that belong broadly speaking to the same field of Laser Induced Fluorescence. These documents came to my attention during the patent search, but they do not seem to have any relevance to the specific goal of this invention. These patents publications are:
(d) U.S. Pat. No. 4,758,727 by Tomei et al., application # 828694, Filed Feb. 12, 1986, Issued Jul. 19, 1988.
(e) U.S. Pat. No. 4,877,966 by Tomei et al., application # 150293, Filed Jan. 29, 1988, Issued Oct. 31, 1988.

Both method and apparatus described in this application were disclosed to the USPTO under the Disclosure Document Protection program on May 25, 2004. USPTO disclosure document # 554523. A copy of the stamped USPTO receipt of the disclosure is enclosed in this correspondence together with a copy of the disclosure filed.

### SUMMARY OF THE INVENTION

The object of my invention is a LIF based method for detecting gaseous mercury. The method object of this invention may be embodied in two different forms.

(a). One photon LIF: in the one photon LIF gaseous mercury is excited along one of the spectral lines (i.e. 253.7 nm corresponding at the 6³P₁-6¹S₀ transaction) by a LASER beam and its fluorescent light is then detected at a convenient wavelength (i.e. a strongly red shifted spectral line like the one at 1014 nm) by a detector.

(b) Two photon LIF: in the two photon LIF gaseous mercury is pumped to a first excited state (for example along the 6³P₁-6¹S₀ transition along the 253.7 nm line) by a first LASER pulse. Then a second LASER pulse excites the mercury atom from its excited state to a higher level (for example along the 7¹S₀-6³P₁ transition at 407 nm). The LASER induced fluorescent signal is then detected at a convenient wavelength (for example in correspondence of the blue shifted line at 184.9 nm) by a detector coupled with a photomultiplier.

### DESCRIPTION OF DRWAINGS

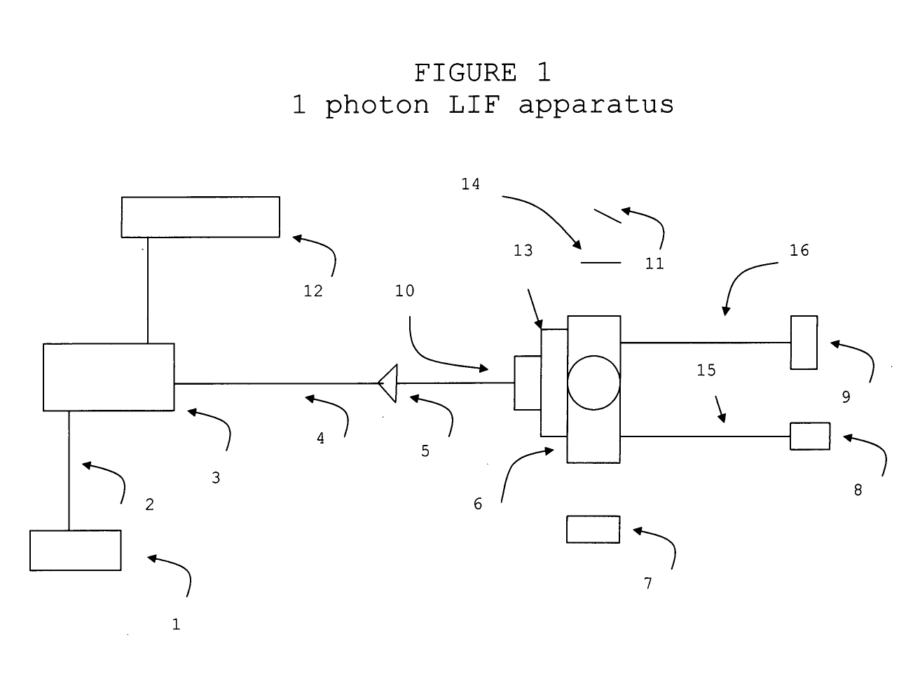

One of the possible embodiments for the one photon LIF apparatus for the detection of gaseous mercury is described in FIG. 1 of the drawing and the individual components are illustrated in the following paragraphs.

FIG. 1, Item (1): PC. FIG. 1, Item (2): connection cable. FIG. 1, Item (3): Oscilloscope. FIG. 1, Item (4): signal cable. FIG. 1, Item (5): signal amplifier.

FIG. 1, Item (6): detection chamber. FIG. 1, Item (7): beam block. FIG. 1, Item (8): sample source. FIG. 1, Item (9): vacuum pump, or vacuum line. FIG. 1, Item (10): photo multiplier tube, or other equivalent detector.

FIG. 1, Item (11): mirror. FIG. 1, Item (12): LASER. FIG. 1, Item (13): optical filter pack. FIG. 1, Item (14): lens or telescope (optional). FIG. 1, Item (15): gas line where the sample flows to the detection chamber.

FIG. 1, Item (16): discard line where the sample is flushed out of the detection chamber.

Note that for environmental applications of in situ determination of gaseous mercury, the detection chamber, the sampling system and the vacuum line and pump may be omitted.

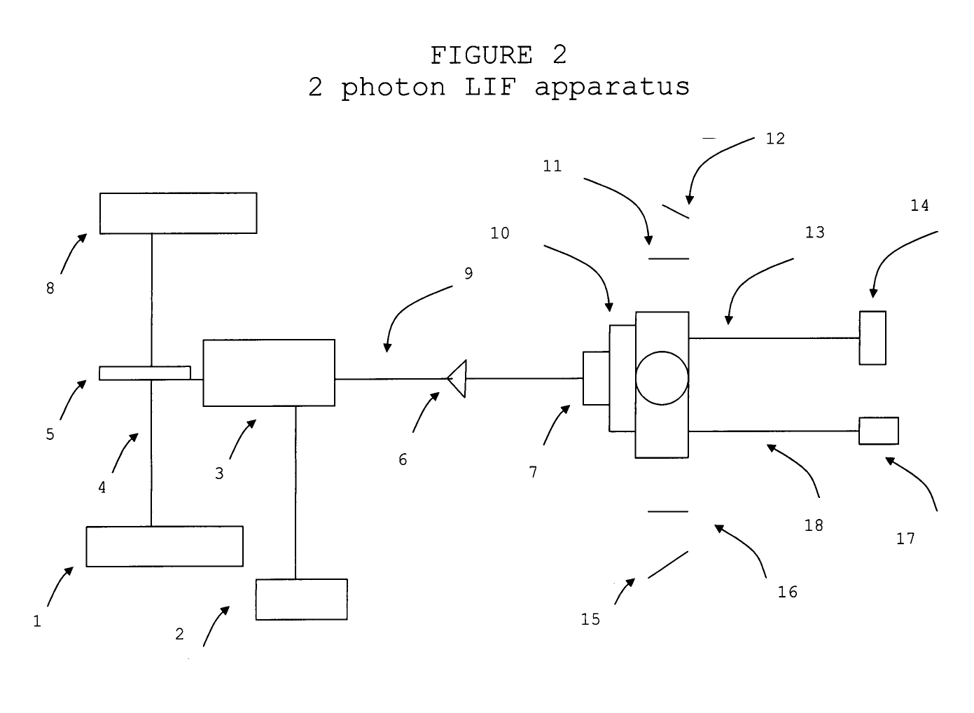

One possible embodiment of the two photon LIF apparatus is described in FIG. 2. The explanation of the items is as follow.

FIG. 2, Item (1): A first LASER system. FIG. 2, Item (2): A Personal Computer, or PD, or an equivalent device. FIG. 2, Item (3): an oscilloscope, or other equivalent data collecting device. FIG. 2, Item (4): A cable to deliver the trigger signal to the LASER system. FIG. 2, Item (5): A delay generator.

FIG. 2, Item (6): A signal amplifier (optional). FIG. 2, Item (7): A photomultiplier Tube or an equivalent device. FIG. 2, Item (8): A second LASER system. FIG. 2, Item (9): A signal cable. FIG. 2, Item (10): A optical filter pack.

FIG. 2, Item (11): A lens or a telescope. FIG. 2, Item (12): A first mirror (may be omitted, or substituted with more complex optic depending on the beam pathway). FIG. 2, Item (13): A sample line to flow the sample from the sampling device to the detection chamber. FIG. 2, Item (14): A sampling device, or a sample source. FIG. 2, Item (15): A second mirror (may be omitted, or substituted with more complex optic depending on the beam pathway.

NOTE: The beam path depends on the more convenient arrangement of the apparatus on a proper support. So the spatial disposition of the elements described in FIGS. 1 and 2, may be different.

FIG. 2, Item (16): A lens, or a telescope (may be omitted). FIG. 2, Item (17): A vacuum pump. FIG. 2, Item (18): a vacuum line.

### DETAILED DESCRIPTION OF THE INVENTION

The object of my invention is a LIF based method for detecting gaseous mercury. The method object of this invention may be embodied in two different forms.

(a) One photon LIF: in the one photon LIF gaseous mercury is excited along one of the spectral lines (i.e. 253.7 nm corresponding at the 6³P₁-6¹S₀ transaction) by a LASER beam and its fluorescent light is then detected at a convenient wavelength (i.e. a strongly red shifted spectral line like the one at 1014 nm) by a detector.

The general topic of the efficiency of gases in quenching excited mercury is discussed in the reference by Michael, 1974. Due to the high efficiency of Nitrogen and Oxygen to quench mercury in its excited state the one photon LIF detection method has less sensitivity than the two photon LIF. On the other hand, due to the relative simplicity to build the one photon LIF apparatus, this scheme may be employed to determine mercury concentrations in media like interstellar clouds, or in atmospheres of other planets lacking of Oxygen, Nitrogen, and Water vapor. Due to the potential influence of the buffer gas on the intensity of the fluorescent signal both the one photon LIF and the two photons LIF must be calibrated periodically, and at any change of gaseous matrix. Calibration can be performed by measuring the gaseous mercury concentration of a known standard. Another way to calibrate either the one photon LIF or the two photon LIF is by comparing the measurement of both methods or by comparing them with a third independent method for gaseous mercury detection.

(b) Two photon LIF: in the two photon LIF gaseous mercury is pumped to a first excited state (for example along the 6³P₁-6¹S₀ transition along the 253.7 nm line) by a first LASER pulse. Then a second LASER pulse excites the mercury atom from its excited state to a higher level (for example along the 7¹S₀-6³P₁ transition at 407 nm). The LASER induced fluorescent signal is then detected at a convenient wavelength (for example in correspondence of the blue shifted line at 184.9 nm) by a detector coupled with a photomultiplier.

Table one (1) below is considered useful for an appropriate clarification and understanding of the invention.

The apparatus to detect gaseous mercury using the one photon LIF is composed by:
(1) A LASER system;
(2) A tubing system to deliver the gaseous mercury in a detection chamber;
(3) A detection chamber;
(4) A photomlultiplier tube (PMT) detector;
(5) An appropriate filter package;
(6) A data acquisition device;
(7) A data processing unit.

A sample of a gaseous mixture containing mercury is delivered in the detection chamber trough a tubing system. The detection chamber is a region of space where the lased beam is focused. It may be a physical chamber internally covered with inert material to prevent any contamination of the sample or any potential reaction between the excited species formed during the detection process. The detection chamber has at least two apertures: one to let the LASER beam into the chamber, the other one to apply the PMT detector.

A physical detection chamber may not be essential as long as proper optic is provided to focus the LASER beam in a region of space that may be open as long as it allows the detection of the fluorescent light. Optic usually needed to focus a LASER are lenses, or telescopes, that can be used alone or in combination, depending on the physical layout of the instrumentation. Optic usually needed for the detection includes filters, telescopes, and lenses. Filters with appropriate cutoff are used to block the radiation coming from the LASER beam, and to minimize the background. Lenses, alone or in combination, may be used to focus the fluorescent light into a PMT. In the drawings the PMT is mounted directly on a cross shaped detection chamber and the optical filter that remains in the interior interface between the chamber and the PMT is not shown.

In general the detection chamber can be just a physical place where the excitation/detection process takes place, and not an enclosed space.

When the sample is flowing trough the chamber the LASER is fired at an appropriate wavelength, that we will call excitation wavelength, so to excite the gaseous mercury from its ground state to an excited state.

TABLE ONE (1)
Comparison of One Photon LIF vs two Photon LIF

| | One Photon LIF | Two Photon LIF |
|---|---|---|
| Detection limit | 1-5 ng m⁻³ in air | 0.1 ng m⁻³ in air |
| Differences | Requires: | Requires: |
| in the | 2 LASERS | 1 LASER |
| Experimental | 1 detector | 1 detector |
| setup | 1 delay generator | |
| Detection Scheme | Flexible: many | Fixed: |
| | excitation/detection | a limited number of |
| | schemes may be chosen. | excitation/detection |
| | | schemes are available. |

The LASER shot may be generated either by a continuous wave (CV) LASER or by an oscillating (for example a 10 Hertz) LASER system. Advantages and disadvantages of both apparatuses are described below. Sufficient optic is needed to deliver the LASER light into the detection chamber. Optic may include mirrors, prism, lenses, filters, attenuators, and other common objects obvious to one of ordinary skill in the art. The specific amount of optical component needed may vary and depends primarily from the optical pathway choose to deliver the LASER beams into the detection chamber and to deliver the mercury fluorescent light into the PMT. In our apparatus it is a goal of the system designer to minimize the optic needed in order to deliver the maximum amount of radiation to the detection chamber and to the PMT. In the drawing referring to the 1 photon LIF apparatus there are 1 prism or mirror and 1 filter, while in the drawing describing the 2 photon LIF apparatus there are two mirrors of prisms, and 2 filters.

Excited mercury atoms spontaneously decay spontaneously to their original ground state both by thermal and not thermal processes emitting fluorescent light at different wavelengths characteristic of the Mercury spectra. The PMT detector collects the fluorescent light. The PMT detector transforms the light intensity into an electrical signal proportional to the fluorescent light collected. It then passes the electrical signal onto an appropriate data acquisition device. Under appropriate experimental conditions the electric signal is proportional to the mercury concentration in the detection volume. The detection volume is the region of space where the PMT is focused. The width of the spectral lines characteristic of elements is very narrow, in this case since both emission and absorption take place in competition with thermal processes we assume an uncertainty of ±0.5 nm. For example when we mention the line at 184.9 nm we intent to cover the range of the electromagnetic spectrum from 184.4 nm to 185.4 nm.

A series of signal amplifier or electric filters may be inserted between the PMT and the data acquisition device to improve the signal to noise ratio. The signal is not absolute in nature. There is not any a priory relationship between the concentration of the Mercury atoms in the detection area and the intensity of the electrical signal. This relationship must be established at the beginning by calibrating the apparatus. One way to calibrate the method is to measure the mercury concentration independently with another method giving an absolute signal. Another way is to build a calibration curve on known concentrations of mercury in the detection area. In general the calibration curve should be built in a range of concentration as close as possible to the range of the unknown. The calibration curve can be built after the measurements, once the unknown signal are already read and stored.

Depending from the transition chosen for the excitation/detection an appropriate optical filter pack must be installed between the PMT detector and the detection chamber. Ideally the optical filter pack shields the PMT detector from any light but the detection wavelength, isolating completely the PMT from the LASER radiation.

The main inconvenience of the one photon LIF signal is the short lifetime of the excited mercury species and the interference between the light coming from the LASER pulse and the fluorescent light. So far two possible detection schemes can be hypothesized for the one photon LIF:
(a) The detection wavelength is longer than the excitation wavelength;
(b) The detection wavelength is the same of the excitation wavelength.

Both schemes have pros and cons that vary with the specific context of the determination. Potential scheme include, but are not limited to the ones mentioned in table two (2).

The main improvement of the combination of the method/apparatus over the current literature is related to:
(a) The choice of the LASER system;
(b) The choice of the analytical matrix more appropriate for this method.
(c) The combination of the most appropriate wavelength for the excitation/detection scheme.

One of the LASER systems described in the object of this invention is a fixed wavelength LASER generating a LASER pulse between 1 μpJoule and 10 mJoule. A fixed wavelength LASER system is easier to handle and does not require any change in the optical components once the apparatus is optimized. Either a CW or an oscillating LASER system may be used.

TABLE TWO (2)

| | |
|---|---|
| Excitation wavelength [nm] | Detection wavelength [nm] |

Previously published combination

| | |
|---|---|
| 184.95 | 184.95 |

Not previously published combinations

| | |
|---|---|
| 184.95 | 546.07 |
| 184.95 | 1,013.9 |
| 253.65 | 1,013.9 |
| 365.01 | 546.07 |
| 435.83 | 546.07 |
| 435.83 | 1,013.97 |
| 404.65 | 1,013.97 |
| 365.01 | 1,013.97 |

LASER power it is a critical variable in this method: for LASER pulse powers higher than 10 mJoules the gaseous mercury gets saturated and the relationship between the fluorescent light and the actual concentration of the mercury in the detection chamber is no longer linear.

For LASER powers lower than 0.1 μJoule there is no detectable fluorescent light, at least under the current experimental conditions. LASER power can be monitored by a Power meter, or by calibrated photodiodes coupled with an oscilloscope, or by other equivalent devices.

The size of the LASER beam is also another critical issue: changing the size of the beam causes a change in the detection volume. An optimal diameter range for the LASER beam is between 0.1 cm and 3 cm. To keep the size of the beam in check it is suggested to use an appropriate calibrated circular aperture on the side of the detection chamber where the LASER beam enters the chamber.

The size of the LASER beam can be monitored by an appropriate apparatus positioned on the opposite side of the detection chamber. Said apparatus may be a photodiode or a photographic paper or any light sensitive device obvious to somebody with ordinary skill in the art.

The LASER beam entering the detection chamber may be focused by a lens to optimize the intensity of the LASER light.

Another variable that must be optimized is the flow rate: this is dependent by the goal of the experiment and it may vary from zero up to 1 standard liter per minute (SLM).

The two photon LIF experimental apparatus is another possible embodiment of the object of this invention. In addition to the components of the one photon LIF apparatus the two photon LIF apparatus includes:
(8) A second LASER system;
(9) A delay generator.

In the two photons LIF two photons are used to excite the mercury atoms. The first photon pumps the Hg atom from its ground state to a first excited state. Then the second photon further excites the mercury atom to a specific second excited state. From this second and higher excited states the mercury atoms decay spontaneously emitting fluorescent light.

The fluorescent light is then collected by a photomultiplier tube (PMT) at an appropriate wavelength. Excitation/detection schemes tried in the past include, but are not limited to the ones illustrated in table three (3). Two or more PMTs can be used to detect the fluorescent light. The advantage of having more than one PMT relies in having two independent monitoring devices, and in case of default of one to be left with the other one.

We find that there are numerous other potential combinations that may result obvious to a person of ordinary skills in the art after this disclosure.

One of the detection schemes object of this invention both in the one photon LIF and in the two photons LIF has the detection wavelength in the infra red portion of the electromagnetic spectrum. This allows a strongly red-shifted observation wavelength and makes it easier to discriminate against the excitation wavelength using an optical filter.

Mercury atoms in the second excite state may loose the extra energy both by thermal and non thermal processes: so part of the difficulty is to identify those transitions that are easier to detect under appropriate experimental conditions.

TABLE THREE (3)

| | | |
|---|---|---|
| First excitation | Second Excitation | Detection |
| Wavelength [nm] | Wavelength [nm] | Wavelength [nm] |

Previously published detection schemes

| | | |
|---|---|---|
| 253.7 | 407.8 | 184.9 |
| 253.7 | 435.8 | 184.9 |
| 253.7 | 435.8 | 546.1 |

Not previously published detection schemes

| | | |
|---|---|---|
| 253.7 | 407.8 | 1,013.9 |
| 184.9 | 365.0 | 1,013.9 |
| 184.9 | 546.0 | 1,013.9 |
| 184.9 | 435.8 | 1,013.9 |
| 184.9 | 296.7 | 1,013.9 |
| 253.7 | 1,013.9 | 184.9 |
| 435.8 | 1,013.9 | 184.9 |
| 435.8 | 1,013.9 | 253.7 |
| 435.8 | 546.0 | 1,013.9 |

I found that both nitrogen and oxygen are good quenchers for the excited mercury atom. So the signal to noise ratio may be greatly improved by using this apparatus to measure gaseous mercury concentration in outer space or on planets whose atmosphere contains no or little of either gases.

In the two photon LIF apparatus it is critical the synchronization between the two LASER shot. This may be provided by an appropriate delay generator. Failure to synchronize and optimize the time between the two LASERS may result in poor results.

The two photon LIF has the advantage to be more specific and to have a lower detection limit than the one photon LIF.

One photon LIF method is less complex and requires lesser optics and electronics. The two photon LIF embodiment is more sophisticated, more sensitive but at the same time requires more extensive optics.

BEST MODE: The analytical capabilities of both the one photon LIF and in the two photons LIF, to our best understanding are maximized by a strongly red or blue shifted detection wavelength. This because independently from the relative intensity of the lines a wider gap between excitation wavelength(s) and detection wavelength minimizes optical noise and potential interferences.

I claim:

1. A process for the 1-photon LIF detection of gas phase metal mercury comprising the steps of: (a) Flowing a sample of gaseous mercury in a region of space called detection chamber; (b) Firing a LASER beam at a specific wavelength indicated as excitation wavelength; (c) Detecting the fluorescent light emitted by excited mercury atoms at a wavelength called detection wavelength with a Photomultiplier Tube (PMT) or other equivalent detector; (d) Passing the PMT signal to an amplifier, and then to an oscilloscope or equivalent electronic component; (e) Collecting the integrate oscilloscope signal on a Personal Computer (PC); (f) Recording said signal in a file; (g) Transforming the integrated signal into a concentration units; (h) Displaying both the signal value and the final concentration result on a screen.

2. The process of claim one where said excitation wavelength is selected by the group of the mercury lines consisting essentially of the lines at 89.308 nm, 109.926 nm, 126.882 nm, 253.653 nm, 296.728 nm, 365.015 nm, 404.656 nm, 435.833 nm, 546.074 nm, 614.950 nm, 1013.975 nm, 1357.021 nm, 1357.021 nm, 1367.351 nm, 1797.279 nm.

3. The process of claim one where said detection wavelength is selected by the group of the mercury lines consisting essentially of the lines at 89.308 nm, 109.926 nm, 126.882 nm, 253.653 nm, 296.728 nm, 365.015 nm, 404.656 nm, 435.833 nm, 546.074 nm, 614.950 nm, 1013.975 nm, 1357.021 nm, 1357.021 nm, 1367.351 nm, 1797.279 nm.

4. The process of claim one where the power of the LASER beam is between 1 μJ/pulse and 10 mJ/pulse.

5. The process of claim one where said LASER beam is monitored by a power-meter.

6. The process of claim one where said fluorescent light is monitored by two different PMT or equivalent devices.

6. A process for the 2-photon LIF detection of gas phase metal mercury comprising the steps of: (a) Flowing a sample of gaseous mercury in a region of space called detection chamber; (b) Firing a first LASER beam at a specific wavelength indicated as first excitation wavelength; (c) Firing a second LASER beam at a specific wavelength indicated as second excitation wavelength; (d) Detecting the fluorescent light emitted by excited mercury atoms at a wavelength called detection wavelength with a Photomultiplier Tube (PMT) or other equivalent detector; (d) Passing the PMT signal to an amplifier, and then to an oscilloscope or equivalent electronic component; (e) Collecting the oscilloscope signal on a Personal Computer (PC); (f) Recording said signal in a file; (g) Transforming the integrated signal into a concentration units; (h) Displaying both the signal value and the final concentration result on a screen.

7. The process of claim six where said first excitation wavelength is selected by the group of the mercury lines consisting essentially of the lines at 89.308 nm, 109.926 nm, 126.882 nm, 296.728 nm, 365.015 nm, 404.656 nm, 546.074 nm, 614.950 nm, 1013.975 nm, 1357.021 nm, 1357.021 nm, 1367.351 nm, 1797.279 nm.

8. The process of claim six where said second excitation wavelength is selected by the group of the mercury lines consisting essentially of the lines at 89.308 nm, 109.926 nm, 126.882 nm, 253.653 nm, 296.728 nm, 365.015 nm, 404.656 nm, 435.833 nm, 546.074 nm, 614.950 nm, 1013.975 nm, 1357.021 nm, 1357.021 nm, 1367.351 nm, 1797.279 nm.

9. The process of claim six where said detection wavelength is selected by the group of the mercury lines consisting essentially of the lines at 89.308 nm, 109.926 nm, 126.882 nm, 253.653 nm, 296.728 nm, 365.015 nm, 404.656 nm, 435.833 nm, 546.074 nm, 614.950 nm, 1013.975 nm, 1357.021 nm, 1357.021 nm, 1367.351 nm, 1797.279 nm.

10. The method of claim six where the power of said first LASER beam is between 1 μJ/pulse and 10 mJ/pulse.

11. The method of claim six where the power of said second LASER beam is between 1 μJ/pulse and 10 mJ/pulse.

12. The process of claim six where said first LASER beam is monitored by a power-meter.

13. The process of claim six where said second LASER beam is separately monitored by a power-meter or other equivalent device.

14. The process of claim six where said fluorescent light is monitored by two PMTs.

15. The process of claim six where said first LASER beam is focused by a lens or by a telescope.

16. The process of claim six where said second LASER beam is focused by a lens or a telescope.

17. The process of claim six where said fluorescent light is focused by a lens or a telescope.

18. The process of claim six where the background light from said first LASER beam and by said second LASER beam is filtered out from the fluorescent light detected by said PMT, by an optical filter.

19. A process as in claim one or six where the absolute concentration of mercury in the detection chamber is periodically calibrated.
